(19) United States
(12) Patent Application Publication
(10) Pub. No.: US 2009/0059018 A1
(43) Pub. Date: Mar. 5, 2009

(54) NAVIGATION ASSISTED MOSAIC PHOTOGRAPHY

(75) Inventor: Michael John Brosnan, Fremont, CA (US)

Correspondence Address: RatnerPrestia, P.O. BOX 980, VALLEY FORGE, PA, 19482, US

(73) Assignee: Micron Technology, Inc., Boise, ID (US)

(21) Appl. No.: 11/850,135

(22) Filed: Sep. 5, 2007

(51) Int. Cl. H04N 5/225

(52) U.S. Cl. 348/218.1; 348/E05.024

(57) ABSTRACT

An imaging apparatus for producing a mosaic image of a scene, including: an imager operable to capture a plurality of images of the scene; a motion sensor coupled to the imager; a transformation processor electrically coupled to the imager and the motion sensor and a mosaic processor electrically coupled to the transformation processor. The motion sensor is adapted to determine a pitch parameter and a yaw parameter of the imager associated with each captured image of the scene. The transformation processor is adapted to transform each captured image into a mosaic coordinate system using the associated pitch parameter and yaw parameter of the imager. The mosaic processor is adapted to produce a mosaic image of the scene from the transformed images.

### FIELD OF THE INVENTION

The present invention relates to methods and apparatus for producing mosaic images. In particular, these methods and apparatus are used to produce panoramic, and other mosaic, images of a scene.

### BACKGROUND OF THE INVENTION

Virtual reality computer systems seek to mimic the sensory experience associated with moving through three dimensional space using a two dimensional display device. The process requires that displayed images be updated in response to the location or position of a viewer in a defined virtual space. Powerful data processing capabilities are required to determine the appropriate displayed images, and large data storage capabilities are necessary to store the images for each potential view.

Although sometimes entirely fanciful, in many applications the displayed images are in whole or in part taken from real world scenes. This is common in applications in which the objective is education. For example, the viewer could be shown scenes from a Roman piazza in order to provide an understanding of day-to-day life in the city. Marketing or advertising applications also draw from this use, showing potential customers the marketed goods in an intended environment.

Previously produced panoramic images may be used to simplify the computational task for such applications. Panoramic images provide the continuous scenic backdrop in these applications. These images may extend entirely through 360°.

One method for initially capturing these panoramic images is with a panoramic camera. These devices may involve rotating a specialized imager, which views the scene through a slit, in a circle to capture the panorama in a single continuous image.

Another method involves manually overlapping and cropping a series of images captured at different angles. Available software may allow these discrete images of a scene to be converted into a continuous panoramic image. The process involves rotating a common camera around its optical center or nodal point. During the rotation a series of discrete, overlapping photographs are captured. Rotation about the optical center ensures that perspective does not change from photograph to photograph. Thus, common portions of the panorama in successive photographs should generally match up. The photographs may be transferred into a computer system. There, the stitching software aligns successive photographs and removes any visible seams thus creating a continuous panoramic image.

In many cases, however, it may not be possible, or desirable, for the imager to be smoothly rotated about its optical center. The imager may rotate about other axes (i.e. pitch or roll) between images. Such rotations may significantly complicate the stitching of the images into a single mosaic image.

Embodiments of the present invention may provide an approach that may be incorporated directly into a handheld imager to produce mosaic images in near real time.

### BRIEF DESCRIPTION OF THE DRAWINGS

According to common practice, the various features of the drawings are not to scale. On the contrary, the dimensions of the various features are arbitrarily expanded or reduced for clarity. Included in the drawing are the following figures:

FIG. 1 is a schematic plan drawing illustrating a mosaic imaging apparatus according to one embodiment of the present invention.

FIG. 2 is a wireframe perspective drawing illustrating rotational axes of an imager.

FIGS. 3A, 3B and 3C are schematic drawings illustrating the effects of rotations of an imager on the section of the scene imaged.

FIG. 4 is a flowchart illustrating method for producing a mosaic image of a scene from multiple images captured by an imager according to one embodiment of the present invention.

FIG. 5 is a flowchart illustrating method for producing a mosaic image of a scene from a sequence of images captured by an imager according to one embodiment of the present invention.

### DETAILED DESCRIPTION OF THE INVENTION

Embodiments of the present invention use motion sensor information to determine the orientation of an imager as each of a number of images of a scene are captured. This orientation information is then used in a mosaic construction method. This approach allows for the production of mosaic images of scenes almost in real time. Additionally, embodiments of the present invention include mosaic imaging apparatus designs that may be integrated into small handheld devices, such as camcorders, digital cameras, portable computers, and cell phones.

It is also noted that although embodiments of the present invention may be used to produce panoramic images for virtual reality application, these embodiments may also be used to produce mosaic images of a scene that have a greater angular extent and/or greater resolution than is possible in a single image of the scene captured by the imager.

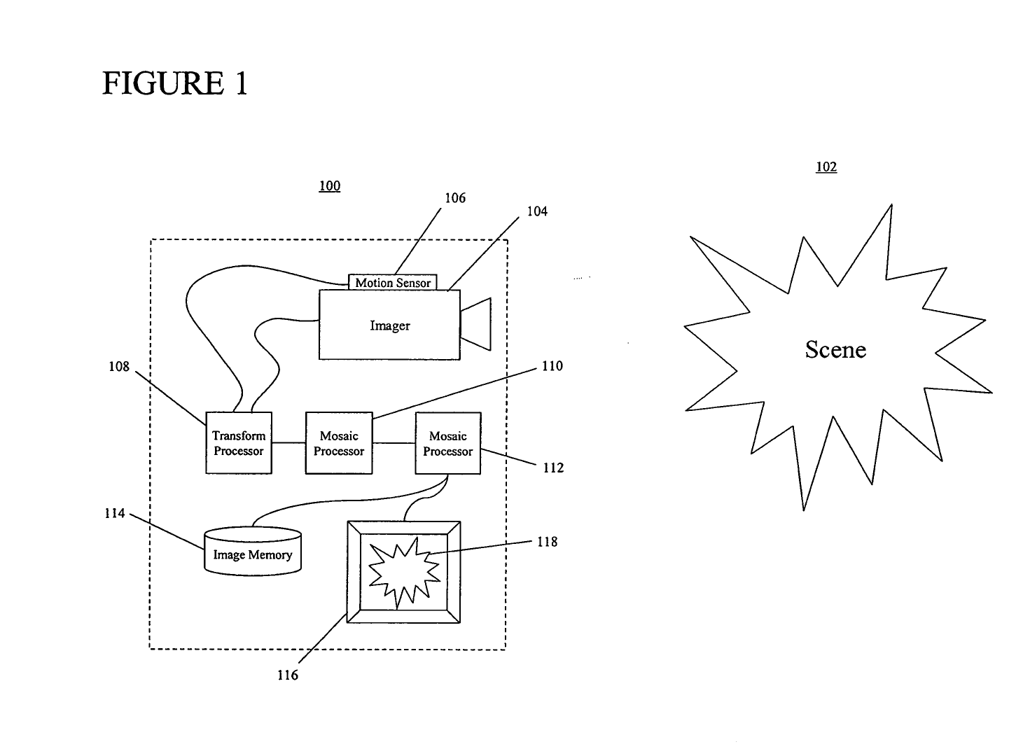

FIG. 1 illustrates one embodiment of the present invention, namely imaging apparatus 100, which may be used, as shown in FIG. 1, to produce mosaic images of scene 102. Imaging apparatus 100 includes: imager 104; motion sensor 106 coupled to imager 104; transformation processor 108, which is electrically coupled to imager 104 and motion sensor 106; and mosaic processor 110, which electrically coupled to transformation processor 108. As shown in FIG. 1, imaging apparatus 100 may also include: cropping processor 112; image memory 114; and/or image display 116 (shown displaying mosaic image 118 of scene 102). Cropping processor 112, image memory 114, and image display 116 are electrically coupled to mosaic processor 110, although image memory 114 and image display 116 may be electrically coupled to mosaic processor 110 through cropping processor 112 (if cropping processor 112 is included).

Imager 104 is operable to capture multiple images of the scene from different orientations. It may be a still camera or a video camera. It is noted that while visible imagers are most common, embodiments of the present invention may use other types of imagers, such as infrared, terahertz, and X-ray imagers.

As imager 104 captures the multiple images to be combined into a mosaic image, motion sensor 106 is used to determine a pitch parameter and a yaw parameter of the imager associated with each captured image of the scene. Motion sensor 106 may also be adapted to determine a roll parameter of the imager associated with each captured image. The pitch parameter, yaw parameter, and roll parameter are numeric representations of the pitch, yaw, and roll of imager 104 determined by motion sensor 106.

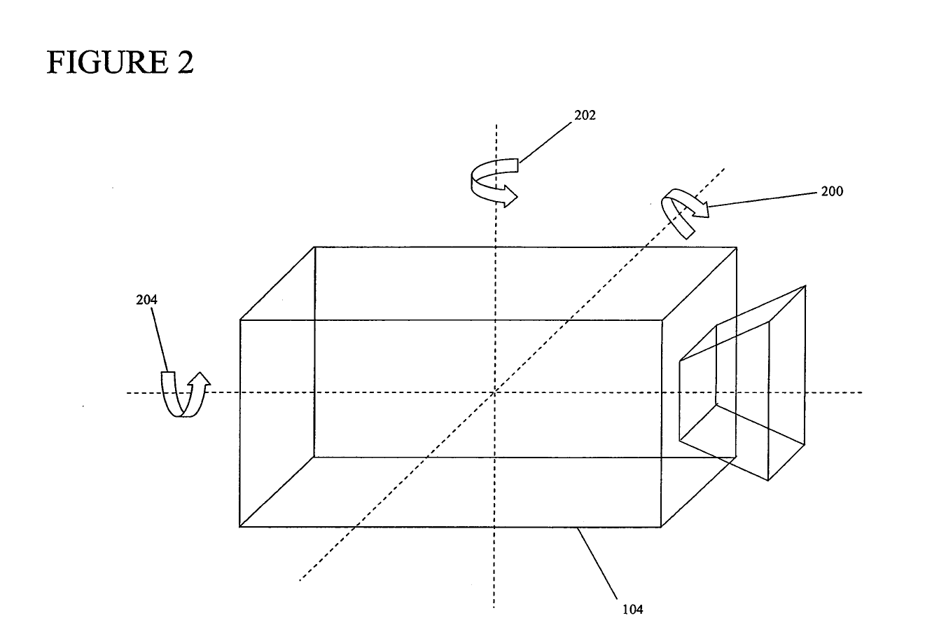

FIG. 2 illustrates the relationship of these three rotational motions. In FIG. 2, imager 104 is represented as a wireframe. As used herein, pitch 200 and yaw 202 are rotations about the two orthogonal axes that are orthogonal to the optical axis of imager 104, and roll 204 is a rotation about the optical axis. Pitch 200 is a rotation about an axis aligned to a central row of pixels in imager 104 and yaw 202 is a rotation about an axis aligned to a central column of pixels in imager 104.

Returning to FIG. 1, motion sensor 106 may include any type of motion sensor, such as an optical motion sensor or a gyroscopic motion sensor.

Commonly assigned US Pat. Appln. Pub. No. 2007/0046782, herein incorporated by reference, discloses an optical motion sensor that may be used in embodiments of the present invention. This optical motion sensor includes at least two sensor devices that are each operable to capture one or more sensor images. A lenslet array is positioned such that one lenslet is in the imaging path of each sensor device. The lenslet are aligned so that the sensor images captured by each sensor device differ from the sensor images captured by the other sensor devices. A correlation processor is electrically coupled to the sensor devices. This correlation processor is adapted to determine the pitch parameter and the yaw parameter (and roll parameter) of the imager using the one or more sensor images of each sensor device.

Commonly assigned US Pat. Appln. Pub. No. 2006/0131485, herein incorporated by reference, discloses another optical motion sensor that may be used in embodiments of the present invention. This optical motion sensor includes at least one sensor device and a correlation processor.

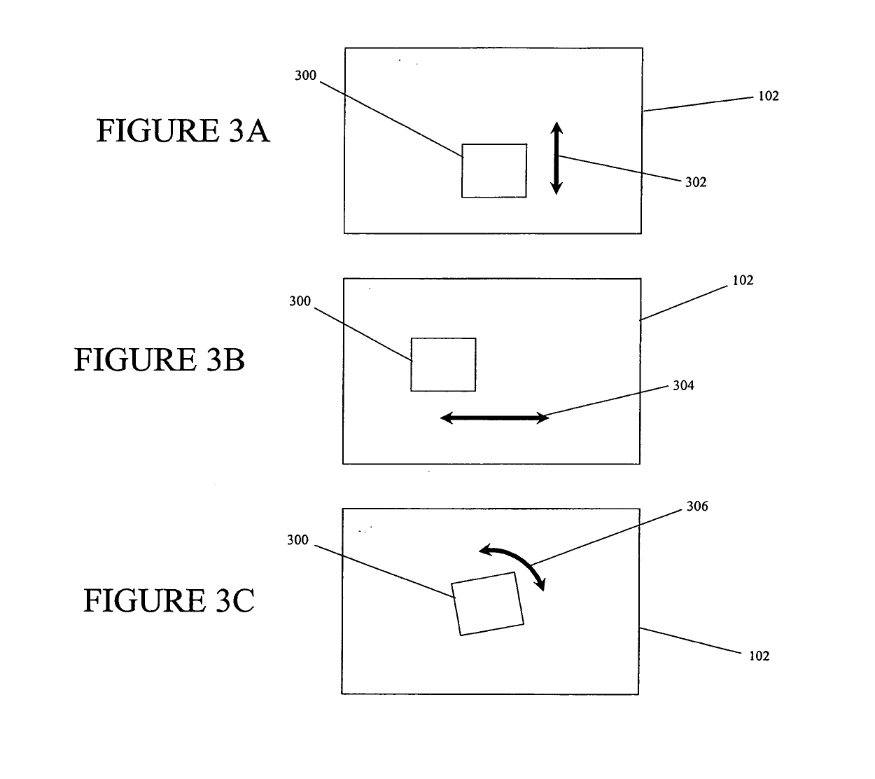

Transformation processor 108 is adapted to transform each captured image into a mosaic coordinate system using the pitch parameter and the yaw parameter (and the roll parameter, if it is determined) of imager 104 associated with the image. FIGS. 3A-C illustrate the affect of the pitch, yaw, and roll of imager 104 on portion 300 of scene 102 captured by imager 104 in a single image. FIG. 3A illustrates how the pitch of imager 104 may cause captured portion 300 to be translated in scene 102 as indicated by arrow 302. FIG. 3B illustrates how the yaw of imager 104 may cause captured portion 300 to be translated in scene 102 as indicated by arrow 304. FIG. 3C illustrates how the roll of imager 104 may cause captured portion 300 to rotate in scene 102 as indicated by arrow 306. It is noted that, if the roll of imager 104 is determined, the directions of translations 302 and 304 caused by the pitch and yaw of imager 104, respectively, are rotated. Thus, if roll is not significant (e.g. <˜1°), using only the pitch parameter and the yaw parameter to transform the coordinates of each captured image may simplify the computation, without reducing the quality of the resulting mosaic image.

The transformed images are used by mosaic processor 110 to produce mosaic image 118 of scene 102. Because the coordinates of the pixels of the transformed images are in a common coordinate system, the mosaic coordinate system, the transformed images are easily overlaid. Overlapping portions of the overlaid images may be cropped so that only pixels from one image remain in these areas. Alternatively, the pixels of the overlapping portions may be blended to create mosaic pixels for these areas.

The resulting mosaic image may be saved in image memory 114 and/or displayed on image display 116; however, this mosaic image may be irregularly shaped, depending on the orientation of the various images used to produce the mosaic image. Therefore, cropping processor 112 may be included to crop the mosaic image produced by mosaic processor 110 to form a mosaic image of scene 102 that includes a contiguous rectangular of mosaic pixels. Cropping processor 112 may automatically crop the mosaic image to produce the largest contiguous rectangular mosaic image possible from the irregular mosaic image. Alternatively, cropping processor 112 may allow a user to select a portion of the total mosaic image, for example, by using a cursor displayed on image display 116 to indicate desired crops.

Transformation processor 108, mosaic processor 110, and cropping processor 112 may include one or more application specific integrated circuits (ASIC's) and/or special purpose processor circuitry. The ASIC(s) and/or circuitry may be wholly separate or may be shared between two, or all three, of these processors. Alternatively, a general purpose processor programmed to perform the functions of one or more of these processors may be used in imaging apparatus 100.

Image memory 114 may include any of a number of different storage media, such as: flash memory; RAM; a hard disk or other non-volatile memory; or a buffer. Image display 118 may be any sort of display device. For example, in the case when imaging apparatus is integrated into a cell phone, image display 118 may be a miniature liquid crystal display or an electroluminescent display.

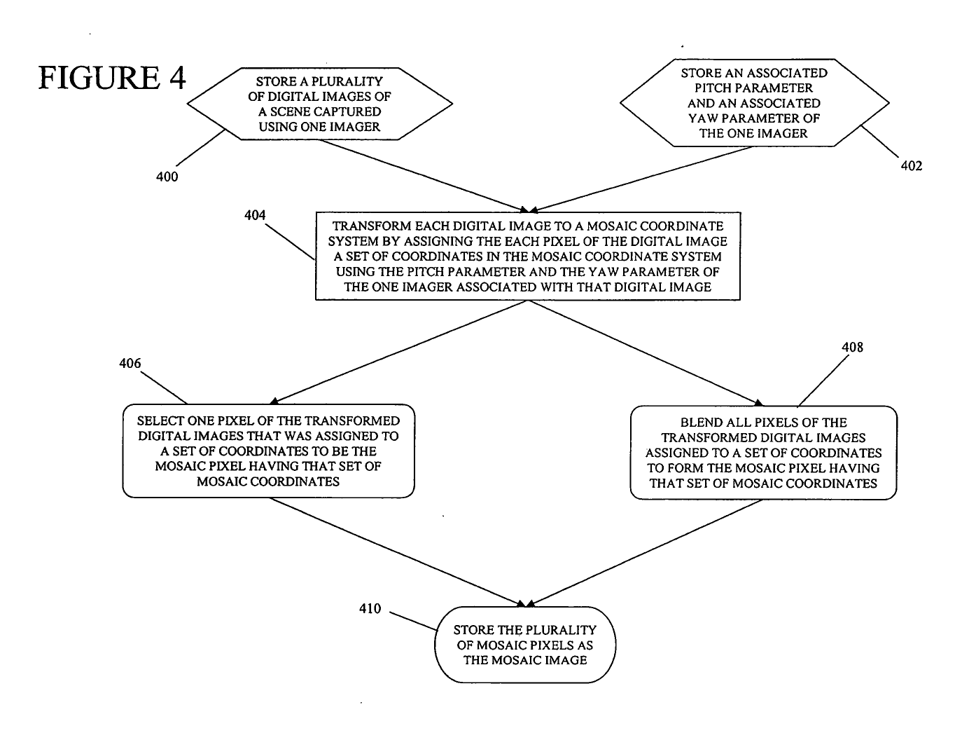

FIG. 4 illustrates a method for producing a mosaic image of a scene from images of the scene captured by an imager according to an embodiment of the present invention. This method may use imaging apparatus 100 of FIG. 1; however, one skilled in the art will understand that it is not so limited.

Each image of the scene, which includes a plurality of pixels, is stored in step 400. This storage may occur on any of a number of different storage media, including: flash memory; RAM; a hard disk or other non-volatile memory; or a buffer. Such storage may include pixel values and pixel coordinates to identify each pixel.

Concurrently with the storage of each image, an associated pitch parameter and an associated yaw parameter of the imager are stored in step 402. As described above with reference to FIG. 3C, it may be desirable to store an associated roll parameter of the imager as well. This storage may also take place in any of a number of different storage media; however, it may be convenient to use the same storage medium as used for the images in step 400.

The pitch parameter, yaw parameter, and roll parameter are numerical values corresponding to a pitch angle, a yaw angle, and a roll angle of the imager, respectively. The pitch angle may be measured from any preselected angle, however, one convention is to measure it from a position in which the optical axis of the imager is horizontal. The yaw angle may be measured from any preselected angle, however, one convention is to set the yaw angle equal to zero for the first image. The roll angle may be measured from any preselected angle, however, one convention is to measure it from a position in which the axis about which the pitch rotation is measured is horizontal.

As described above with reference to FIG. 1, various techniques may be used to determine the pitch and yaw (and roll) parameters of the imager associated with each image. Many such techniques are known to one skilled in the art. Among these techniques are the use of gyroscopic motion sensors and the use of optical motion sensors.

In certain embodiments, two (or more) motion sensor images of a section of the scene are stored. The motion sensor images capture a section of the scene that is within the associated image. The motion sensor images also have less information than the images of the imager. For example, these motion sensor images may image a smaller section of the scene and/or produce a lower resolution image. Further, the motion sensor images may be grayscale, even if the images are in color.

A motion vector for the section of the scene is determined using these motion sensor images. Commonly assigned US Pat. Appln. Pub. No. 2007/0046782 discloses techniques in which the motion vector for a section of the scene is determined from the sensor images by correlating the motion sensor images of one sensor device. Commonly assigned US Pat. Appln. Pub. No. 2006/0131485 discloses other techniques in which the motion vector for a section of the scene is determined from the sensor images. In these techniques, one motion sensor image is subtracted from another motion sensor image captured by the same sensor device to generate a motion sensor difference image. One of these two motion sensor images is correlated to the motion sensor difference image to determine the motion vector for the corresponding section of the scene.

The pitch parameter and the yaw parameter of the imager may then be determined from the motion vector. It is noted, however, that these techniques determine a motion vector for only a section of the scene. It may be difficult, therefore, to use these techniques to determine the roll parameter of the imager. Additionally, if there is significant roll, using the motion vector of only one section of the scene may undesirably reduce the accuracy of the embodiment. Commonly assigned US Pat. Appln. Pub. No. 2007/0046782 discloses an approach to overcome these issues by using multiple sensor devices to capture motion sensor images from different sections of the scene. Motion vectors for each section are determined and the motion vector may then be compared to determine the pitch and yaw (and roll) parameters of the imager associated with each image.

Each image is transformed to a mosaic coordinate system in step 404. This transformation involves assigning each pixel of the image a set of coordinates in the mosaic coordinate system. The pitch parameter of the imager associated with an image may be used to determine a Y-axis translation of the image and the yaw parameter may be used to determine an X-axis translation of the image. These axes may be rotated along with the image using the roll parameter.

In addition to translating and rotating each image using the pitch parameter and the yaw parameter (and the roll parameter) in step 404 may include transforming each image by undistorting the image. This undistorting transformation may be accomplished using lens parameters, such as the focal length and the field of view, of the imager associated with that image.

Once the images are transformed into a common mosaic coordinate system, the images may be overlaid. The mosaic image is produced by combining the pixel data of the transformed images such that each set of coordinates in the mosaic coordinate system has a single pixel value. The embodiment of FIG. 4 illustrates two alternative approaches to combining the overlapped pixel data. These two approaches may be used exclusively for every pixel in a mosaic image or may be used in different portions of the mosaic image based on predetermined criteria. When only one pixel is assigned to a particular set of mosaic coordinates, the approaches lead to the same result: use that pixel as the mosaic pixel.

One approach to combining the pixel data of the transformed images is step 406, selecting one pixel of transformed images that was assigned to that set of mosaic coordinates in step 404 to be the mosaic pixel having those mosaic coordinates. Various schemes may be used to determine which pixel to select when multiple pixels are assigned to the same set of mosaic coordinates. For example, the images of the scene may be ranked in a hierarchy and the pixel of the image that is highest in the hierarchy may be selected for each set of mosaic coordinates. Alternatively, the pixel that is closest to the center of its transformed image may be selected. This second scheme assumes that any distortion of the images becomes greater farther from the image center.

Another approach to combining the pixel data of the transformed images, step 408 in FIG. 4, is to blend all pixels of the transformed images that have been assigned to a given set of coordinates to form the corresponding mosaic pixel. These pixels may be blended to form the mosaic pixel by performing a mathematical function, such as averaging, on the pixel values of the pixels assigned to that set of mosaic coordinates. Although potentially more computationally involved that the alternative approach of step 406, this approach may allow for improved smoothing of the boundaries between the images, making the mosaic image appear more seamless.

As described above with reference to the embodiment of FIG. 1, some of the mosaic pixels may be cropped to form a contiguous rectangular mosaic image. If this cropping is performed automatically, it may be performed before the pixel data of the transformed images are combined to improve efficiency.

The mosaic pixels may then be stored as the mosaic image in step 410. The mosaic image may also be displayed, and may be further processed, if desired.

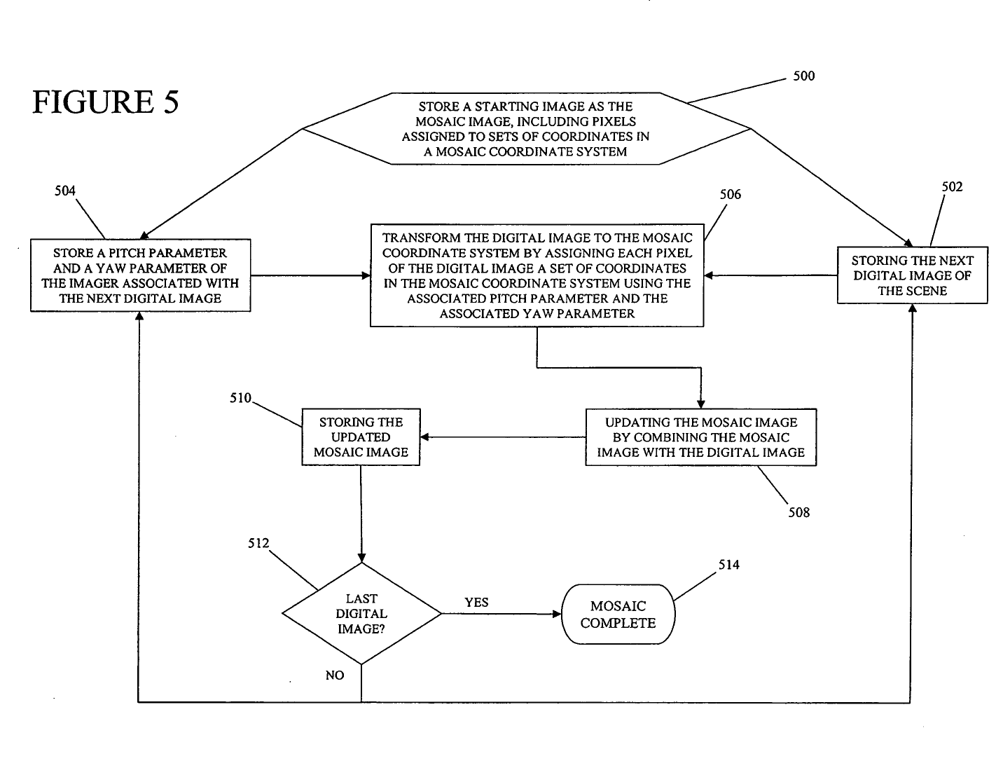

FIG. 5 illustrates a method for producing a mosaic image of a scene from a sequence of images of the scene that have been captured by an imager. This sequence of images may include a sequence of video frames.

A starting image of the sequence of images is stored as the mosaic image in step 500. This image includes a plurality of pixels assigned to sets of coordinates in a mosaic coordinate system.

The next image of the scene is stored in step 502, and a pitch parameter and a yaw parameter of the imager that are associated with the image are stored in step 504. As in the method of FIG. 4 described above, a roll parameter of the imager associated with the image may also be stored. The pitch parameter and the yaw parameter (and roll parameter if determined) are measured relative to the position of the imager associated with the starting image. These rotational parameters may be determined as described above with reference to the method of FIG. 4.

The image is transformed, in step 506, to the mosaic coordinate system by assigning each pixel of the image a set of coordinates in the mosaic coordinate system using the associated pitch and yaw (and roll) parameters. Any of the techniques for transforming images described above with reference to the method of FIG. 4 may be used.

The mosaic image is then updated, in step 508, by combining the mosaic image with the transformed image. Several approaches to combining these images to update the mosaic image may be used.

For example, one approach is to maintain the previous mosaic image and only add new pixels from the transformed image. Thus, for every set of mosaic coordinates that includes a previously assigned pixel in the mosaic image, that previously assigned pixel may be selected to remain as the mosaic pixel having that set of mosaic coordinates. For every set of mosaic coordinates that includes a newly assigned pixel in the transformed image, but does not include a previously assigned pixel in the mosaic image, the newly assigned pixel is selected to be that mosaic pixel.

Another approach is to use all the pixels of the transformed image and only retain previously assigned pixels of the mosaic image that do not overlap the transformed image. Thus, for every set of mosaic coordinates that includes an assigned pixel in the transformed image, the assigned pixel may be selected as the mosaic pixel having that set of mosaic coordinates. For every set of mosaic coordinates that includes a previously assigned pixel in the mosaic image, but does not include an assigned pixel in the transformed image, the previously assigned pixel is selected to remain as that mosaic pixel.

A further approach is to blend the pixels of the transformed image and the previously assigned pixels of the mosaic image wherever they overlap. Thus, a set of mosaic coordinates that includes a newly assigned pixel in the transformed image, but does not include a previously assigned pixel in the mosaic image, the newly assigned pixel is selected to be that mosaic pixel. For every set of mosaic coordinates that includes a previously assigned pixel in the mosaic image, but does not include an assigned pixel in the transformed image, the previously assigned pixel is selected to remain as that mosaic pixel. For every set of mosaic coordinates that includes a previously assigned pixel in the mosaic image and an assigned pixel in the transformed image, the pixels are blended to form the new mosaic pixel having that set of mosaic coordinates.

The updated mosaic image is stored in step 510. It is then determined in decision box 512, whether the image just added to the mosaic image is the last image in the sequence. If it is the final image in the sequence, the mosaic is complete as determined in step 514. If the sequence includes additional digitals images, the next image in the sequence is stored in step 502, the rotational parameters associated with that image are stored in step 504. Steps 506, 508, 510, and 512 are repeated for that image.

Although the invention is illustrated and described herein with reference to specific embodiments, it is not intended to be limited to the details shown. Rather, various modifications may be made in the details within the scope and range of equivalents of the claims and without departing from the invention.

What is claimed:

1. A method for producing a mosaic image of a scene from a plurality of images of the scene captured by an imager, comprising the steps of:
storing the plurality of images of the scene, each image including a plurality of pixels;
concurrently with the storage of each image, storing an associated pitch parameter of the imager and an associated yaw parameter of the imager;
transforming each stored image by assigning each pixel of the stored image a set of coordinates in a mosaic coordinate system using the associated pitch parameter and yaw parameter of the imager; and
for each set of coordinates in the mosaic coordinate system, performing one of:
selecting one assigned pixel of the plurality of transformed images as a mosaic pixel having that set of mosaic coordinates; or
blending all assigned pixels of the plurality of transformed images to determine the mosaic pixel having that set of mosaic coordinates.

2. A method according to claim 1, further comprising the step of:
storing the plurality of mosaic pixels as the mosaic image.

3. A method according to claim 1, further comprising, concurrently with the storage of each image, the steps of:
storing two motion sensor images of a section of the scene;
determining a motion vector for the section of the scene using the two motion sensor images; and
determining the associated pitch parameter and yaw parameter of the imager using the motion vector.

4. A method according to claim 3, wherein the motion vector for the section of the scene is determined by correlating the two motion sensor images.

5. A method according to claim 3, wherein the motion vector for the section of the scene is determined by:
subtracting one motion sensor image from the other motion sensor image to generate a motion sensor difference image;
correlating one of the two motion sensor images to the motion sensor difference image.

6. A method according to claim 1, further comprising, concurrently with the storage of each image, determining the associated pitch parameter and yaw parameter of the imager using a gyroscopic sensor in the imager.

7. A method according to claim 1, wherein each image is transformed into the mosaic coordinate system using:
the associated pitch parameter of the imager to determine a Y-axis translation of the image; and
the associated yaw parameter of the imager to determine an X-axis translation of the image.

8. A method according to claim 1, wherein:
transforming each image into the mosaic coordinate system includes undistorting each image using lens parameters of the imager associated with that image; and
the lens parameters include focal length and field of view.

9. A method according to claim 1,
further comprising, concurrently with the storage of each image, storing an associated roll parameter of the imager;
wherein each image is transformed into the mosaic coordinate system using the associated pitch parameter, yaw parameter, and roll parameter of the imager.

10. A method according to claim 9, further comprising, concurrently with the storage of each image, the steps of:
storing two motion sensor images of a first section of the scene;
storing two motion sensor images of a second section of the scene that differs from the first section of the scene;
determining a first motion vector for the first section of the scene using the two motion sensor images of the first section of the scene;
determining a second motion vector for the second section of the scene using the two motion sensor images of the second section of the scene; and
determining the associated pitch parameter, roll parameter, and yaw parameter of the imager using the first motion vector for the first section of the scene and second motion vector for the second section of the scene.

11. A method according to claim 9, further comprising, concurrently with the storage of each image, the steps of:
storing two motion sensor images of each of a plurality of sections of the scene, each section of the scene differing from other sections in the plurality of sections of the scene;
determining a motion vector for each section of the scene using the two motion sensor images of that section of the scene; and
determining the associated pitch parameter, roll parameter, and yaw parameter of the imager using the plurality of motion vectors for the plurality of sections of the scene.

12. A method according to claim 9, further comprising, concurrently with the storage of each image, determining the associated pitch parameter, yaw parameter, and roll parameter of the imager using a gyroscopic sensor in the imager.

13. A method according to claim 9, wherein each image is transformed to the mosaic coordinate system using:
the associated roll parameter of the imager to determine:
a rotation of the image; and
an X-axis and a Y-axis of the image;
the associated pitch parameter of the imager to determine a Y-axis translation of the image; and
the associated yaw parameter of the imager to determine an X-axis translation of the image.

14. A method according to claim 1, wherein:
the plurality of images of the scene have a hierarchy;
for each set of coordinates in the mosaic coordinate system, among all of the assigned pixels, the assigned pixel of the image that is highest in the hierarchy is selected as the mosaic pixel having that set of mosaic coordinates.

15. A method according to claim 1, wherein, for each set of coordinates in the mosaic coordinate system, among all of the assigned pixels, the assigned pixel that is closest to a center of its transformed image is selected as the mosaic pixel having that set of mosaic coordinates.

16. A method according to claim 1, wherein, for each set of coordinates in the mosaic coordinate system, the assigned pixels of the plurality of transformed images are blended to determine the mosaic pixel having that set of mosaic coordinates by averaging pixel values of the assigned pixels.

17. A method according to claim 16, further comprising, cropping the plurality of mosaic pixels to form a contiguous rectangular of mosaic pixels as the mosaic image.

18. A method for producing a mosaic image of a scene from a sequence of images of the scene captured by imager, comprising the steps of:
storing a starting image of the sequence of images as the mosaic image, including a plurality of pixels assigned to sets of coordinates in a mosaic coordinate system; and
for each remaining image of the sequence of images:
storing the image of the scene;
storing a pitch parameter and a yaw parameter of the imager that are associated with the image, the pitch parameter and the yaw parameter measured relative to a position of the imager associated with the starting image;
transforming the image by assigning each pixel of the image a set of coordinates in the mosaic coordinate system using the associated pitch parameter and yaw parameter of the imager;
updating the mosaic image by combining the mosaic image with the transformed image; and
storing the updated mosaic image.

19. A method according to claim 18, further comprising the step of:
storing the updated mosaic image.

20. A method according to claim 18, wherein the sequence of images of the scene includes a sequence of video frames.

21. A method according to claim 18,
further comprising, for each remaining image of the sequence of images, storing an associated roll parameter of the imager, the associated roll parameter measured relative to the position of the imager associated with the starting image;
wherein the image is transformed to the mosaic coordinate system using the associated pitch parameter, yaw parameter, and roll parameter of the imager.

22. A method according to claim 18, wherein updating the mosaic image includes:
for every set of mosaic coordinates that includes a previously assigned pixel in the mosaic image, selecting the previously assigned pixel of the mosaic image as the mosaic pixel having that set of mosaic coordinates; and
for every set of mosaic coordinates that includes an assigned pixel in the transformed image and does not include a previously assigned pixel in the mosaic image, selecting the assigned pixel of the transformed image as the mosaic pixel having that set of mosaic coordinates.

23. A method according to claim 18, wherein updating the mosaic image includes:
for every set of mosaic coordinates that includes an assigned pixel in the transformed image, selecting the assigned pixel of the transformed image as the mosaic pixel having that set of mosaic coordinates; and
for every set of mosaic coordinates that includes a previously assigned pixel in the mosaic image and does not include an assigned pixel in the transformed image, selecting the previously assigned pixel of the mosaic image as the mosaic pixel having that set of mosaic coordinates.

24. A method according to claim 18, wherein updating the mosaic image includes:
for every set of mosaic coordinates that includes an assigned pixel in the transformed image and does not include a previously assigned pixel in the mosaic image, selecting the assigned pixel of the transformed image as the mosaic pixel having that set of mosaic coordinates;
for every set of mosaic coordinates that includes a previously assigned pixel in the mosaic image and does not include an assigned pixel in the transformed image, selecting the previously assigned pixel of the mosaic image as the mosaic pixel having that set of mosaic coordinates; and
for every set of mosaic coordinates that includes a previously assigned pixel in the mosaic image and an assigned pixel in the transformed image, blending the previously assigned pixel of the mosaic image with the assigned pixel in the transformed image to determine the mosaic pixel having that set of mosaic coordinates.

25. An imaging apparatus for producing a mosaic image of a scene, comprising:
an imager operable to capture a plurality of images of the scene;
a motion sensor coupled to the imager, the motion sensor adapted to determine a pitch parameter and a yaw parameter of the imager associated with each captured image of the scene;
a transformation processor electrically coupled to the imager and the motion sensor, the transformation processor adapted to transform each captured image into a mosaic coordinate system using the associated pitch parameter and yaw parameter of the imager; and
a mosaic processor electrically coupled to the transformation processor, the mosaic processor adapted to produce the mosaic image of the scene from the plurality of transformed images.

26. An imaging apparatus according to claim 25, wherein the imager includes at least one of: a still camera; or a video camera.

27. An imaging apparatus according to claim 25, wherein the motion sensor includes at least one of: an optical motion sensor; or a gyroscopic motion sensor.

28. An imaging apparatus according to claim 25, wherein the motion sensor includes:
a plurality of sensor devices each operable to capture one or more sensor images;
a lenslet array comprised of a plurality of lenses, each lens is positioned in an imaging path of a respective sensor device such that the one or more sensor images captured by one of the sensor devices in the plurality of sensor devices differs from the sensor images captured by the other sensor devices; and
a correlation processor electrically coupled to the plurality of sensor devices, the correlation processor adapted to determine the associated pitch parameter and yaw parameter of the imager using the one or more sensor images of each sensor device.

29. An imaging apparatus according to claim 25, wherein:
the motion sensor is further adapted to determine a roll parameter of the imager associated with each captured image of the scene; and
the transformation processor is further adapted to transform each captured image into a mosaic coordinate system using the associated pitch parameter, yaw parameter, and roll parameter of the imager.

30. An imaging apparatus according to claim 25, wherein the transformation processor includes at least one of:
an application specific integrated circuit (ASIC);
special purpose processor circuitry; or
a general purpose processor programmed to transform each captured image into the mosaic coordinate system using the associated pitch parameter and yaw parameter of the imager.

31. An imaging apparatus according to claim 25, wherein the mosaic processor includes at least one of:
an application specific integrated circuit (ASIC);
special purpose processor circuitry; or
a general purpose processor programmed to produce the mosaic image of the scene from the plurality of transformed images.

32. An imaging apparatus according to claim 25, further comprising a cropping processor electrically coupled to the mosaic processor, the cropping processor adapted to crop the mosaic image produced by the mosaic processor to form a contiguous rectangular of mosaic pixels as the mosaic image of the scene.

33. An imaging apparatus according to claim 25, further comprising image memory electrically coupled to the mosaic processor to store the mosaic image of the scene.

34. An imaging apparatus according to claim 25, further comprising an image display electrically coupled to the mosaic processor to display the mosaic image of the scene.

35. An imaging apparatus according to claim 25, wherein the imaging apparatus is integrated into one of: a camcorder; a digital camera; a portable computer; or a cell phone.
